(19) United States
(12) Patent Application Publication
(10) Pub. No.: US 2026/0104357 A1
(43) Pub. Date: Apr. 16, 2026

(54) LIGHT EMISSION AND REFLECTIVE ANALYZING SYSTEM AND METHOD

(71) Applicant: Matthew Keith Kurlan, Carlsbad, CA (US)

(72) Inventor: Matthew Keith Kurlan, Carlsbad, CA (US)

(21) Appl. No.: 18/912,556

(22) Filed: Oct. 10, 2024

(51) Int. Cl. G01N 21/39

(52) U.S. Cl. CPC G01N 21/39; G01N 2201/08

(57) ABSTRACT

The invention provides a system and method for analyzing light reflection and absorption to alter targeted surfaces while preserving surrounding areas. The system utilizes a tunable light emitter and a spectroscopic analyzer to identify wavelengths that are absorbed by the target but reflected by the background. The light emitter is then tuned to transmit those specific wavelengths, inducing a photo-thermal reaction in the target. This allows for precise surface alterations, such as cleaning or removal of specific materials, without affecting adjacent areas. Applications include medical procedures, industrial processing, and surface cleaning.

### BACKGROUND

### Field of the Invention

The present invention relates generally to the employment of projected light to visualize and to interact with surfaces. More particularly it relates to a device and method employing frequency-specific light transmission and reflection reception therefrom, to both observe and affect a targeted surface or substance.

### Description of the Related Art

Materials exposed to light transmissions can either pass light through the material when the material is sufficiently transparent, absorb light by the material, reflect light from the material surface, or a combination thereof. The reflection of transmitted light contacting a material surface occurs where the wavelengths of the light waves striking a material surface, fail to match the vibration frequency of the molecules forming that object. The absorption of transmitted light contacting a material surface occurs wherein the frequencies of the light waves striking the material surface match the vibration frequency of the molecules forming that object.

When natural or artificially generated light waves in various light wavelengths strike an object, electrons in the atoms forming the object will vibrate. The electrons vibrate for brief periods of time with small amplitudes in their vibration whereupon the light energy is re-emitted from the material contacted, as a light wave. Where the material forming an object is transparent these vibrations of the electrons forming it are communicated to other atoms forming the transparent material and then re-emitted on the side of the material opposite the side where the original light waves made contact.

Where the material forming an object is not transparent and is instead opaque, the vibrations of the electrons forming the material caused by the emitted light striking it, do not communicate through the atoms forming the material. In a material which is formed of molecules rendering it opaque, the electrons of the atoms struck by the emitted light on the material surface will vibrate for short periods of time, and then the energy in the light striking the material will form a reflected light wave.

This reflected light wave will be affected as to color by the vibration and absorption of portions of the emitted light spectrum striking the object which are absorbed or affected by the vibration of the atoms forming it. Thus, the atoms of a material forming an object will vibrate when contacted with a light emission and absorb or otherwise affect the color of the reflected light from the surface of that object. As such, the atoms of the material forming the object, can be determined by discerning the light frequencies reflected, and those absorbed or affected by the atoms of the material from which a reflected light is emitted.

With respect to the above, before explaining at least one preferred embodiment of the system herein, it is to be understood that the disclosed light emission and Analyzing device and system are not limited in application to the details of employment and to the arrangement of the components or the steps set forth in the following description or illustrated in the drawings. The light emission and reflection Analyzing system herein, and operations thereof disclosed, are capable of other embodiments, and of being practiced and carried out in various ways, all of which will be obvious to those skilled in the art once the information herein is reviewed.

Also, it is to be understood that the phraseology and terminology employed herein are for the purpose of description, and should not be regarded as limiting. As such, those skilled in the art will appreciate that the conception upon which this disclosure is based, may readily be utilized for other light generation and Analyzing systems. It is important, therefore, that the embodiments, objects and claims herein, be regarded as including such equivalent construction and methodology insofar as they do not depart from the spirit and scope of the present invention.

### SUMMARY

In practical applications, the light generated and employed to effect photo-thermal reactions is conventionally laser generated. Such generated light may be at a wavelength which is arbitrary or which is calculated or convenient, depending upon the source element. However, emitted light of such a wavelength may fail to discriminate precisely between those substances which are intended to be affected by the light so generated and by those substances which are not.

The system and method herein disclosed and described below takes advantage of the fact that specific differences in spectral absorption yielding reflected light, may be inapparent to the naked eye. However, such spectral differences between the broadcast light to an object and the reflected light therefrom, may be readily discerned through the employment of a spectrophotometer.

By comparing the differences in light frequency between the originally emitted light upon an object, and the reflected light therefrom, and tuning the wavelength of the light emissions from the source light accordingly, these light frequency differences between the emitted light and reflected light may be utilized to more specifically target molecules forming substances which are intended to be made to undergo a photo thermally induced reaction. Further, such a photo thermally induced reaction can be very specific as to a material to be affected, while leaving those substances which are not intended to undergo such a reaction substantially unchanged.

As such, by employing such a tuned light generation and light reflection system, adjacent or background substances from those intended to be affected, are preserved. Concurrently, the targeted substances may undergo a photo-thermal reaction or vaporization at a precisely selected wavelength which may first be determined by discerning the light waves reflected by the substance and those absorbed.

In medical applications of the system herein, such a means to determine light emissions which will affect a specific target material, while leaving adjacent material substantially unchanged, can significantly enhance the outcome of the medical procedure. This is because conventionally such a spectral analysis has been limited to material which has been extracted and then positioned physically into a remote spectral Analyzing machine for analysis.

Through the employment of signal amplification technology of the device and system herein, the device and system can perform a comparable spectral analysis using light emissions which are transmitted a greater distance from a light emitting source which are then reflected back from the object being analyzed while situated in an existing position or media.

Employing the disclosed device and system herein, such spectral analysis of targeted materials may be performed through the employment of fiberoptic light transmission channels. Such will thus provide for material or tissue spectral analysis through the employment of fiberoptic channels. The employment of fiberoptic channels for light transmission and reception will thus allow for analysis & treatment of living tissues in real time such as during surgery. Such will also allow for the reduced invasiveness in many medical applications. Finally, the device and system herein can save significant time through the provision of real time analysis of materials and substances thereby increasing the effectiveness of medical procedures as well as providing increased efficiency in industrial and processing of chemical substances.

With respect to the above description, before explaining at least one preferred embodiment of the herein disclosed light emission and analyzation system herein, it is to be understood that the invention is not limited in its application to the details of construction and to the arrangement of the components in the following description or illustrated in the drawings. The light emission and reflection Analyzing invention herein described, is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other fiber optic channel light emission and analyzing systems, and for carrying out the several purposes of the present disclosed container device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise defined for size or dimension or positioning of a specific part or configuration, means plus or minus ten percent.

It is an object of this invention to employ real time light transmission and reflection and/or absorption analysis for cleaning, removal, and/or modifying particular surfaces and substances in various industrial and medical applications. Categories can include biologic surfaces, structural surfaces, biologic cavities, structural cavities, chemicals, and biologic fluids. Examples include, but are not limited to, cleaning tartar from teeth, tattoo removal, sterilizing surfaces, cleaning graffiti or dirt from objects/surfaces, vaporization of invasive or pathologic cells within benign tissue, cleaning debris from inside a pipe or container, purification by vaporizing chemical byproducts/contaminants or activating catalytic reaction, and vaporizing micro-plastic contaminants or pathologic cells such as cancer cells or infective agents from blood serum.

It is an object of this invention to employ real time light transmission and reflection analysis through fiber optic channels, to accelerate the analysis of living tissue during medical procedures.

It is a further object of this invention to employ such a system to reduce the invasiveness of medical procedures and to accelerate treatment of patients.

Other objects, features, and advantages of the present fiber optic channelized light transmission and Analyzing system, as well as the advantages thereof over existing prior art, will become apparent from the description to follow, and are accomplished by the improvements described in this specification and hereinafter described in the following detailed description which fully discloses the invention, but should not be considered as placing limitations thereon.

The utility of the system and method as disclosed herein utilizes precise measurement of both the target object and the background. Preferably, the differences in the frequency of absorption and the degree (%) of absorption allow for maximal effect on the target and minimal to no effect on the background. When analyzing those measurements, a certain tolerance for similarities and differences in the frequency and degree of light absorption would be determined by the user, which would be dependent upon the intended application of the system and method. For example, use of the device for a biologic application may require more strict differences in the frequency and degree of light absorption in order to minimize “collateral damage” to background biologic tissues. Whereas use of the device on structural materials might allow for less strict tolerance of similarities in the frequency and degree absorption. For example, and without limitation, use on biologic tissues may require zero or near-zero overlap in light absorption by the target and the background, at the frequency being utilized for effect. Whereas use on structural materials may allow for some degree of overlap in absorption properties.

The system generally has three modalities for proper execution. The first modality is broad spectrum fiber optic light emission aimed sequentially at the target & the background, with sequential absorption measurements by a spectrophotometer. The second modality is a CPU analysis for optimal differences of absorption between the target and the background with variable tolerance set by the user and dependent upon the intended application. And the third modality is a focused light emission at a wavelength, or a combination of wavelengths, as calculated by the CPU and aimed for intended effect on the target with minimal to no effect on the background.

### BRIEF DESCRIPTION OF THE DRAWINGS

Other features, combinations, and embodiments will be appreciated by one having the ordinary level of skill in the art of spectroscopy upon a thorough review of the following details and descriptions, particularly when reviewed in conjunction with the drawings, wherein:

FIG. 1 shows a mode of the system herein, employing a light emitter and computer interface for discerning the reflected light from an object;

FIG. 2 shows an example of software enabled analysis of a substance which may be affected through the discerning of the reflected light frequencies communicated through a fiber optic pathway to the spectroscopic analyzer;

FIG. 3 shows an example of the determining of a light transmission which may be generated by the light emitter which will target and affect a particular material or substance based on the calculation of FIG. 2;

FIG. 4 shows an example of a treatment which may be provided by the system herein, through the communication of light in light frequencies calculated to only affect a targeted area or material upon which the frequency specific light is communicated;

FIG. 5 shows an example of the system with an exhaust conduit and a laser dispersion mechanism; and FIG. 6 shows a flowchart for a method of altering a surface in accordance with an aspect.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “wavelength” and “frequency” are inversely related and the disclosure one of the terms inherently includes disclosure of the other term.

The term “target” means one or more objects and/or surfaces where alteration by the system is desired.

The term “background” means objects and/or surfaces surrounding or nearby the target where alteration by the system is not desired.

The term “light emitter” means a source or a variety of sources, which may be switched from a broad spectrum (for analysis) to a narrow spectrum (for effect), thereby having up to two modalities.

The term “conduit” means a channel, tube, or medium which something is transmitted, conveyed, or distributed.

The term “spectroscopic analyzer” means an instrument used to measure and analyze properties of light over a portion of the electromagnetic spectrum and can detect absorption, emission, and scattering of light by a sample.

The term “photo-thermal reaction” means light that is absorbed by a material and converted to heat.

The term “full reflectivity”and “full reflection”means a reflection of 90% or more.

The term “predominantly reflective” and “predominant reflection” means a reflection of 50% or more.

The term “laser expansion mechanism” means a mechanism used to cover more of an area by a laser through techniques such as oscillation and/or dispersion.

The term “visible spectrum” means a portion of the electromagnetic spectrum visible to the human eye and ranges from about 380 nm to 750 nm in wavelength.

The terms “reflection” and “absorption” refers to inverse spectral properties of molecules. The measurement of either property may be utilized to determine the other.

The term “particulate matter”means vapor, smoke, debris, and the like.

Unless explicitly defined herein, terms are to be construed in accordance with the plain and ordinary meaning as would be appreciated by one having skill in the art.

### General Description of Embodiments

In one general embodiment, a light emission and reflective analyzing system is disclosed. The system comprises a tunable light emitter having a tuning mechanism. An output conduit is operatively coupled to the tunable light emitter. The output conduit is configured to communicate light from the tunable light emitter to a target and a background. A return conduit is configured to communicate reflected light from said target and said background. A spectroscopic analyzer is operatively coupled with the return conduit. The spectroscopic analyzer is configured to detect and measure the reflected and/or absorbed light of each of the target and the background. A processor electrically is coupled to each of the tunable light emitter and the spectroscopic analyzer. The processor is configured to determine an optimal wavelength set, the optimal wavelength set comprising one or more wavelengths that are both predominantly reflected by the background and at least partially absorbed by the target. The processor is further configured to tune the tunable light emitter to transmit at least one wavelength from the optimal wavelength set.

In some embodiments, the optimal wavelength set may comprise one or more wavelengths that are both fully reflected by the background and at least partially absorbed by the target.

In some embodiments, the system may further comprise a filter positioned along the output conduit between the tunable light emitter and the target.

In some embodiments, the system may further comprise a targeting camera operatively coupled to the return conduit to provide graphic depiction on a display screen.

In some embodiments, the system may further comprise an exhaust conduit configured to cool and/or remove particulate matter, the exhaust conduit being independent and distinct from the output conduit and the return conduit.

In some embodiments, the tunable light emitter may further comprise a laser expansion mechanism configured to increase area of coverage of a laser emitted by the tunable light emitter. The laser expansion mechanism may comprise lenses, beam shapers, scanning systems, spatial light modulators, or a combination thereof.

In some embodiments, the output conduit and the return conduit may each comprise fiberoptic channels.

In some embodiments, the system may further comprise a fiber optic scope configured to view and monitor the target and the background during transmission of the tunable light emitter.

In one general aspect, a method of altering a surface is disclosed. The method comprises: (i) transmitting a plurality of light wavelengths to a target; (ii) measuring one or more light wavelengths reflected and/or absorbed by the target; (iii) transmitting a plurality of light wavelengths to a background; (iv) measuring one or more light wavelengths reflected and/or absorbed by the background; (v) determining an optimal wavelength set, wherein the optimal wavelength set comprises one or more wavelengths that are both reflected by the background and at least partially absorbed by the target; (vi) tuning a tunable light emitter to transmit at least one wavelength of the optimal wavelength set to the target; and (vii) inducing a photo-thermal reaction to the target.

In some aspects, the step of inducing the photo-thermal reaction to the target may further comprise concurrently preserving the background.

In some aspects, the method may further comprise adding a photoactive dye to one of the target or the background.

In some aspects, the optimal wavelength set may comprise one or more wavelengths that are both predominantly reflected by the background and at least partially absorbed by the target.

In some aspects, the optimal wavelength set may comprise one or more wavelengths that are both fully reflected by the background and at least partially absorbed by the target.

In some aspects, the method may further comprise cooling at least one of the target and the background.

In some aspects, the method may further comprise exhausting particulate matter caused the photo-thermal reaction.

In some aspects, the method may further comprise measuring one of more wavelengths reflected by both the target and the background is performed by a spectrophotometer.

In some aspects, the photo-thermal reaction may be induced by a laser emitted from the tunable light emitter.

In some aspects, the method may further comprise calculating a difference between a reflection percentage of the background and the reflection percentage of the target for each of the one or more wavelengths; and prioritizing transmission of wavelengths with the greatest difference.

In some aspects, the plurality of light wavelengths transmitted to the target and the background may comprise a visible spectrum.

In some aspects, the plurality of light wavelengths transmitted to the target and the background may comprise a visible spectrum, UV, IR, or a combination thereof.

Each of the components of the tunable laser and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Illustrated Embodiments

In this description, the directional prepositions of up, upwardly, down, downwardly, front, back, top, upper, bottom, lower, left, right, first, second, and other such terms refer to the device as it is oriented and appears in the drawings and are used for convenience only, and they are not intended to be limiting or to imply that the magnifying container device herein has to be used or positioned in any particular orientation.

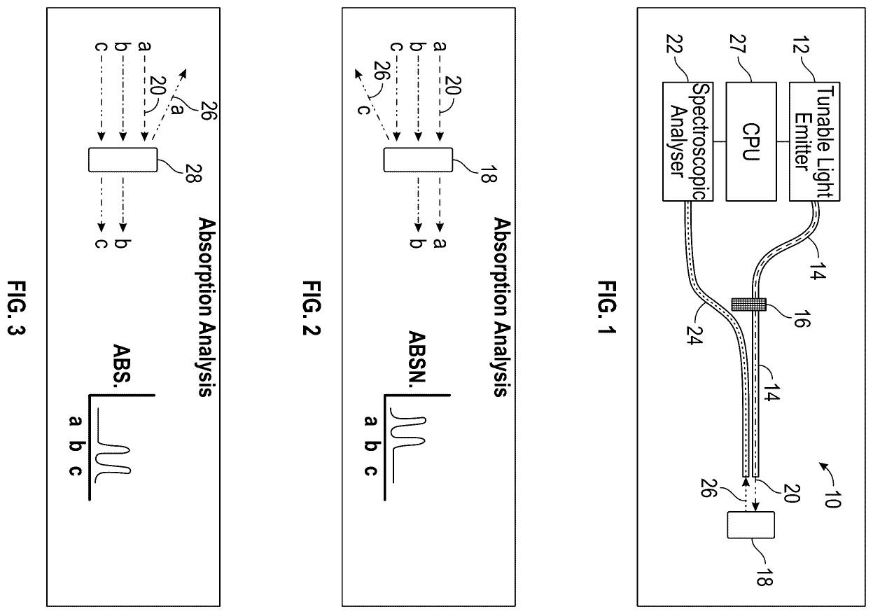

Now referring to drawings in FIG. 1-5 wherein similar components are identified by like reference numerals, there is seen in FIG. 1 the system 10 herein in a graphic depiction of the components in general. As shown, a tunable light emitter 12 is operatively engaged with an output fiber optic 14 conduit which receives emitted light from the light emitter 12 and communicates it through the output fiber optic conduit 14. An optional filter 16 may be positioned along the output fiber optic conduit 14 between the light emitter 12 and the object 18 of interest. The filter 16 may be employed for filtering color or for polarization or other purposes of the emitted light 20 from the light emitter 12. The tunable light emitter 12 comprises two modes, namely a broad-spectrum mode and a frequency-variable mode. The broad-spectrum mode transmits a broad range of wavelengths/frequencies simultaneously or in succession in order to assess which wavelengths/frequencies are being reflected and absorbed by the various surfaces. Broad range can include the visible spectrum, UV, IR, and other kinds of electromagnetic radiation. The second mode comprises a specific tunable frequency-variable where specific wavelengths/frequencies are determined and emitted based on the reflection/absorption behavior of the various surfaces. In other embodiments, the two modes are handled by two separate devices.

Also shown in the system 10 in FIG. 1 is a spectroscopic analyzer 22 which is configured in operative engagement to a return fiber optic conduit 24. The return fiber optic conduit 24 communicates reflected light 26 from the object 18 when it is illuminated with a chosen frequency of emitted light 20 from the light emitter 12. In other embodiments, absorbed light can be measured in addition to or instead of reflected light. The spectroscopic analyzer 22 is configured to wavelengths being reflected by both the target 18 and the background 28. Means for color differentiation can include filter-based detection, photodiodes, charge coupled devices (CCD), or complementary metal-oxide semiconductor (CMOS) sensors.

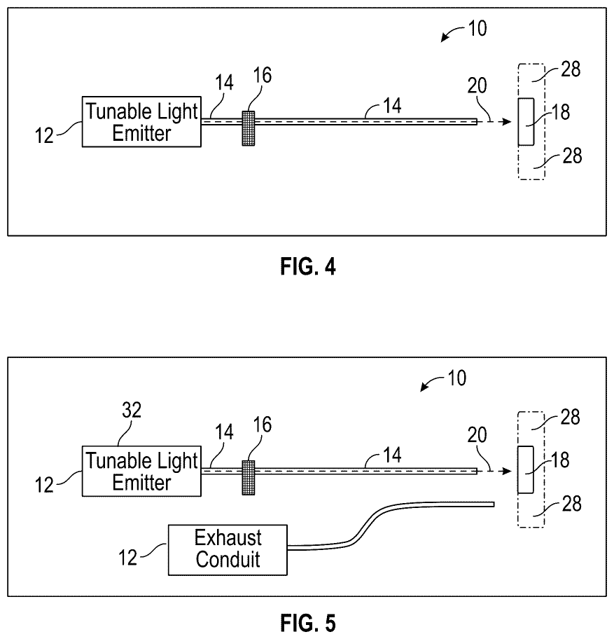

A CPU 27 is in operative electronic communication with both the spectroscopic analyzer 22 and the tunable light emitter 12. The CPU 27 has a computer processor in operative connection to electronic memory in which analyzing software running to the task of reflected light 26 from the object to determine a light frequency of absorbed light by the object, which is not communicated to the spectroscopic analyzer 22 from the return fiber optic conduit 24. The frequency of spectrum of the absorbed light as noted herein, can be employed in a communication thereof to the object 18 to affect its structure while having substantially little or no effect on the surrounding area (FIG. 4). For example, and in no way limiting, the CPU and software running thereon to the task, may determine a light frequency that is not returned in a reflection from the object 18 and into the return fiber optic conduit 24, and is therefore absorbed by the object 18. In a subsequent step, such as in FIG. 4, the light emitter 12 will be tuned via an electronic signal by the CPU 27, to tune the emitted light 20 only to a spectrum or frequency which was determined as absorbed. The emitted light 20 so tuned, would contact the object 20 and heat or otherwise affect its structure, while concurrently, having little or no effect on the surrounding area 28.

The tunable light emitter 12 comprises a tuning mechanism configured to selectively alter the emitted wavelength of the tunable light emitter in order to optimize performance of the system by causing a photo-thermal reaction to the target 18 while having little to no effect to the background 28. The tunable light emitter 12 can include such as HeNe, Argon-Ion, and diode lasers. The tunable light emitter may further comprise a gain medium to allow the tunable light emitter 12 to amplify light by stimulated emission. Example of gain mediums includes dyes dissolved in a liquid solvent, and titanium-doped sapphire crystals to achieve a broader tuning range. Preferably, the gain medium will be pumped using a suitable pump source. For dye lasers this can include an additional laser or a flashlamp. Fir Ti lasers, a green laser such as Nd double to 532 nm can be used. The tuning mechanism can include various subcomponents such as diffraction gradings, prisms, lyot filters, and interferometers. A partially reflective mirror can be used to allow a portion of the laser light to exit a cavity of the tunable light emitter 12 while reflecting the rest back into the gain medium. The tunable light emitter 12 may also need a cooling system to manage heat being generated.

Depicted in FIG. 2, is a graphic example of an absorption analysis to which the software running in electronic memory of the CPU 27 is configured to calculate. The CPU 27 will be in electronic communication with data in electronic memory which will enable the calculation. An electronic signal from the CPU 27 to the light emitter 12 in electronic communication with the CPU 27 will cause the light emitter 12 to adjust the spectrum or frequency of the emitted light 20 to have the desired effect upon the object 18 when communicated through the output fiber optic conduit 14 to the surface of the object 18.

Additionally, a targeting camera (not shown but well known) can be operatively connected with the return fiber optic conduit 24 to provide a graphic depiction on a display screen of the object 18 in its remote position, and for a subsequent targeting thereof.

In FIG. 2 is shown a graphic depiction of the software operating to the task of determining the light frequencies or spectrum which is reflected by the target or object 18, and which frequencies or light spectrum is reflected. As shown, emitted light 20 striking the target reflects light in the spectrum or frequency shown as C. The target or object 18 thus can be determined by the software on the CPU 27, as absorbing multiple frequencies or spectrums of the emitted light 20 which will affect it, and returning reflected light 26 in the spectrum.

FIG. 3 shows an example of software enabled background material analysis by the software running in memory of the CPU 27. As shown, surrounding material 28 to the object 18, which may be affected by the emitted light 20 may be examined through the discerning of the reflected light 26 frequencies communicated through the return fiber optic pathway 24 to the spectroscopic analyzer 22. As shown, emitted light 20 from the light emitter 12 strikes the background or surrounding area 28 adjacent and around the object 18. The surrounding area 28 absorbs all the light frequencies but for that designated as A. Since C is reflected by the target 18 a communication of emitted light 20 to the object 18 in the spectrum or frequency of A, may be employed to affect the object 18, but not the surrounding area 28. In other embodiments, absorbed light can be measured in addition to or instead of the reflected light 26. A function of the method and system disclosed herein is determining which frequencies/wavelengths are absorbed by the target 18 that are also not absorbed by the background 28. Determining these frequencies/wavelengths will allow the target 18 to be affected by light and heat while the surrounding area 28 remains totally unaffected or minimally affected.

Depicted in FIG. 4 depicts is an example of a treatment which may be provided by the system 10 herein, once the reflected light spectrum and absorbed light spectrum has been determined for the target or object 18 using the system herein 10. As shown, the CPU 27 has communicated a signal to the light emitter 12, to only communicate emitted light 20 in one or a plurality of light frequencies calculated to be absorbed by the target or object 18, and reflected by the surrounding area 28. In this fashion, the target or object 18 can be affected by the emitted light 20 while the surrounding area 28 remains totally unaffected or minimally affected.

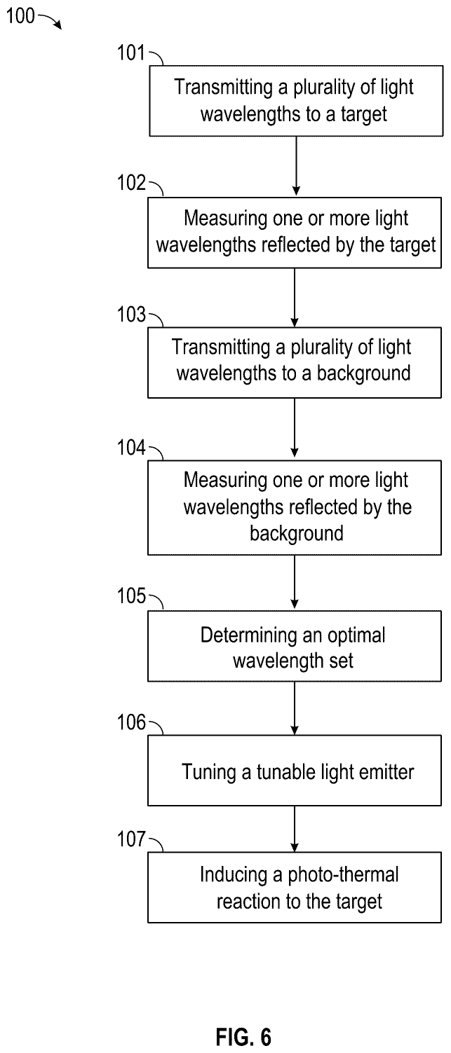

Depicted in FIG. 5 shows an example of the system 10 with an exhaust conduit 30 and a laser dispersion mechanism 32. The exhaust conduit 30 is configured to remove particulate matter like debris, smoke, or debris, coiling the target and/or the background, or both. Under the correct parameters, the target 18 will undergo a photo-thermal reaction which can create debris and vapor during alteration of the target 18. The particulate matter can visually interfere with system performing efficiently. Additionally, the target 18, and to some extent the background 28 may increase in temperature too rapidly or at a high level than desired and therefore cooling may be needed. The intensity and duration of the tunable light emitter can also be adjusted when certain thresholds are being exceeded and a lower power is desired. The laser dispersion mechanism 32 is integrated with the tunable light emitter 12 is utilized to achieve as wider area of coverage by the laser. The laser dispersion mechanism 32 can be achieved oscillation and/or dispersion. The laser dispersion mechanism 32 may comprise but not limited to lenses, beam shapers, scanning systems like galvanometer scanners and polygon scanners, and spatial light modulators like liquid crystal SLMs and digital micromirror devices.

FIG. 6 shows a flowchart for a method of altering a target 100. The method includes the step of (i) transmitting a plurality of light wavelengths to a target 101; (ii) measuring one or more light wavelengths reflected and/or absorbed by the target 102; transmitting a plurality of light wavelengths to a background 103; (iv) measuring one or more light wavelengths reflected and/or absorbed by the background 104; (v) determining an optimal wavelength set 105; (vi) tuning a tunable light emitter 106; and (vii) inducing a photo-thermal reaction to the target 107.

The step of transmitting a plurality of light wavelengths reflected to a target 101 and background 103 can be performed by a breakdown of the visible spectrum into a plurality of single wavelengths. Alternatively, the tunable light emitter can transmit white light which comprises a plurality of light wavelengths and measure which wavelengths are reflected by both the target and the background. The transmitting of the plurality of light wavelengths can occur in sequential order with either the target or the background receiving the plurality of light wavelengths first. Alternatively, the target and the background can each receive the plurality of light wavelengths at the same time. The laser being transmitted to determine reflected wavelengths can be focused in order for the captured reflected light to properly correspond with the transmitted light at each portion of the target or background being measured. This can allow for the measured reflected wavelengths to comprise coordinate metadata in scenarios where certain portions of the target or background have a higher or lesser degree of reflection compared to the remaining portions of the corresponding target or background. In such scenarios, the optimal wavelength set which comprises wavelengths that will cause a photo-thermal reaction to the target while preserving the background may only affect a portion of the target. Alteration of just these portions may still be desirable and so the system can refer to the coordinate metadata where the transmitted optimal wavelength set will be effective and the tunable light emitter would target just those areas.

Measuring one or more light wavelengths reflected by the target 102 and the background 104 can be performed by a spectroscopic analyzer, such as a spectrophotometer. The spectroscopic analyzer is operatively coupled to a return conduit wherein the return conduit sends light reflected by the target and/or background to the spectroscopic analyzer. The spectroscopic analyzer can perform spectral analysis for differentiating colors with various techniques including filter-based detection as well as types of photodiodes and sensors. Using optical filters can allow only certain wavelengths of light to pass through to aid in color differentiation. Types of sensors can include charge-coupled device (CCD) sensors as well as complementary metal-oxide semiconductor (CMOS) sensors that can detect specific wavelengths of light. These sensors can be combined with optical filters or prisms to isolate specific wavelengths before detection. Modern CCD/CMOs sensors often have guilt-in color filters like Bayer filters which allows for the detection of different colors.

The method includes the steps of measuring the reflected light by the target 102 and the background 104 as opposed to measuring light absorbed by the target and background because of the position of the associated system performing the method. The system, which includes the tunable light emitter and spectroscopic analyzer, is positioned in front of the target and the background.

Determining the optimal wavelength set 105 is performed after the reflections by both the target and the background have been measured. The optimal wavelength set is defined as a set of one or more wavelengths that are both reflected by the background and at least partially absorbed by the target. The photo-thermal reaction generally occurs with wavelengths that are absorbed by an object. By determining which wavelengths are both not absorbed by the target (reflected), while also being partially absorbed by the target, the method is capable of achieving a photo-thermal reaction to the target while having minimal or no effect to the background. Generally, the optimal wavelength set comprises wavelengths that each are fully reflected by the background to ensure preservation thereof.

Determining the optimal wavelength set can be calculated logically by the system in various ways that can involve measured reflected wavelengths, calculated absorption wavelengths, or a combination thereof. For example, the system can determine the optimal wavelength set by measuring the reflected wavelengths of both the target and background and determining what the background has and the target does not. In another aspect, the absorbed wavelengths are calculated for the both target and the background and the system determines what the target has and the background does not. In another aspect, the target reflected wavelengths are measured and the background absorption wavelengths are calculated and the system determines which wavelengths are not present in either the target reflected wavelengths and the background absorbed wavelengths. In another aspect, the target absorbed wavelengths are calculated and the background reflected wavelengths are measured and the system determines which wavelengths are present in both the target absorbed wavelengths and the background reflected wavelengths

Once the optimal wavelength set has been determined 105, a tunable light emitter can be tuned 106 with the optimal wavelength set. Once the tunable light emitter has been tuned, which generally is the same light emitter that transmitted the initial light for measuring reflection, the tunable light emitter can then transmit wavelengths from the optimal wavelength set to the target. Any contact by the laser to the background will have little to no effect because of the background's characteristic of reflecting wavelengths of the optimal wavelength set. The tunable light emitter can include a laser dispersion mechanism to cover more of an area over the target than a conventional focused laser. The tunable light emitter can emit a combination of multiple wavelengths from the optimal wavelength set or the tunable light transmitter can emit a single wavelength one at a time. In some aspects, only one wavelength is needed for transmission in order to effectively induce the photo-thermal reaction. In other aspects, multiple wavelengths either in series or parallel can be transmitted to induce the photo-thermal reaction.

In some aspects, wavelengths within the optimal wavelength set can be prioritized based on the target's absorption rate for each wavelength. Wavelengths that have a higher absorption rate can be prioritized to ensure a more effective photo-thermal reaction. Prioritizing can include determining a difference between a reflection percentage of the background and the reflection percentage of the target for each of the one or more wavelengths and prioritizing transmission of wavelengths with the greatest difference. Prioritizing can include not transmitted wavelengths with a lesser difference at all or at fewer intervals. Greatest difference may comprise a particular difference threshold that each of the wavelengths with the greatest difference has in order to qualify as an emitted wavelength for inducing a photo-thermal reaction. Any wavelengths with a lesser difference can be removed from the optimal wavelength set which creates a reformed optimal wavelength set. The difference threshold can be set depending on the application of the method. As an example, the difference threshold may comprise 75%. If the target reflects a particular wavelength at 20% (thereby having an absorption rate of 80%) and the background reflects the particular wavelength at 95%, the difference would be 75% which meets the difference threshold set in this particular example. One having skill in the art will appreciate a myriad of ways of determining prioritization of wavelengths in the optimal wavelength set.

After the tunable light emitter has been tuned to the optimal wavelength set 106, the method can then transmit a laser comprising one or more wavelengths from the optimal wavelength set to the target to induce a photo-thermal reaction 107. The photo-thermal reaction will alter the target while preserving the background from any photo-thermal reaction. This dynamic can allow the target to be cleaned, removed, or otherwise altered without causing any adverse effects to the background.

In some aspects, the method may further comprise adding a photoactive dye to one of the target or the background prior to transmitting the plurality of light wavelengths to either the target 101 or the background 103. The photoactive dye can increase differentiation between the target and the background which can assist in the effectiveness of the system. Photoactive dyes can be especially beneficial in medical applications where the target comprises a tumor. Examples of photoactive dyes can include, but are not limited to, indocyanine green, fluorescein, and methylene blue.

In some aspects, the method may further comprise utilization of a fiber optic for scoping and monitoring the burn caused by the photo-thermal reaction to ensure the rate of burn is at an acceptable rate based on the application.

The description of the features of the light emission and reflective analyzing system invention herein, does not limit the claims of this application, and, other applications developed by those skilled in the art upon reviewing this application are considered to be included in this invention.

It is additionally noted and anticipated that although the depictions and disclosure herein is shown in its most simple form and operation, potential configurations, various components and aspects of the disclosed system may be differently arranged or slightly modified when forming the invention herein. As such, those skilled in the art will appreciate the descriptions and depictions set forth in this disclosure are merely meant to portray examples of preferred modes of the system herein within the overall scope and intent of the invention, and are not to be considered limiting in any manner.

Further, while all of the fundamental characteristics and features of the light emission system have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

### FEATURE LIST

system (10)
light emitter (12)
output fiber optic conduit (14)
filter (16)
object, target (18)
emitted light (20)
spectroscopic analyzer (22)
return fiber optic conduit (24)
reflect light (26)
CPU (27)
background, surrounding area (28)
exhaust conduit (30)
laser dispersion mechanism (32)

What is claimed is:

1. A light emission and reflective analyzing system, comprising:
a tunable light emitter having a tuning mechanism;
an output conduit operatively coupled to the tunable light emitter, the output conduit configured to communicate light from the tunable light emitter to a target and a background;
a return conduit configured to communicate reflected light from said target and said background;
a spectroscopic analyzer operatively coupled with the return conduit, the spectroscopic analyzer configured to detect and measure the reflected and/or absorbed light of each of the target and the background;
a processor electrically coupled to each of the tunable light emitter and the spectroscopic analyzer, the processor configured to determine an optimal wavelength set, the optimal wavelength set comprising one or more wavelengths that are both predominantly reflected by the background and at least partially absorbed by the target, the processor further configured to tune the tunable light emitter to transmit at least one wavelength from the optimal wavelength set.

2. The system of claim 1, wherein the optimal wavelength set comprises one or more wavelengths that are both fully reflected by the background and at least partially absorbed by the target.

3. The system of claim 1, further comprising a filter positioned along the output conduit between the tunable light emitter and the target.

4. The system of claim 1, further comprising a targeting camera operatively coupled to the return conduit to provide graphic depiction on a display screen.

5. The system of claim 1, further comprising an exhaust conduit configured to cool and/or remove particulate matter, the exhaust conduit being independent and distinct from the output conduit and the return conduit.

6. The system of claim 1, the tunable light emitter further comprising a laser expansion mechanism configured to increase area of coverage of a laser emitted by the tunable light emitter.

7. The system of claim 6, wherein the laser expansion mechanism comprises lenses, beam shapers, scanning systems, spatial light modulators, or a combination thereof.

8. The system of claim 1, wherein the output conduit and the return conduit each comprise fiberoptic channels.

9. The system of claim 1, further comprising a fiber optic scope configured to view and monitor the target and the background during transmission of the tunable light emitter.

10. A method of altering a surface, comprising transmitting a plurality of light wavelengths to a target;
measuring one or more light wavelengths reflected and/or absorbed by the target;
transmitting a plurality of light wavelengths to a background;
measuring one or more light wavelengths reflected and/or absorbed by the background;
determining an optimal wavelength set, wherein the optimal wavelength set comprises one or more wavelengths that are both reflected by the background and at least partially absorbed by the target;
tuning a tunable light emitter to transmit at least one wavelength of the optimal wavelength set to the target; and
inducing a photo-thermal reaction to the target.

11. The method of claim 10, the step of inducing the photo-thermal reaction to the target further comprising concurrently preserving the background.

12. The method of claim 10, further comprising adding a photoactive dye to one of the target or the background.

13. The method of claim 10, wherein the optimal wavelength set comprises one or more wavelengths that are both predominantly reflected by the background and at least partially absorbed by the target.

14. The method of claim 10, wherein the optimal wavelength set comprises one or more wavelengths that are both fully reflected by the background and at least partially absorbed by the target.

15. The method of claim 10, further comprising cooling at least one of the target and the background.

16. The method of claim 10, further comprising exhausting particulate matter caused the photo-thermal reaction.

17. The method of claim 10, wherein measuring one of more wavelengths reflected by both the target and the background is performed by a spectrophotometer.

18. The method of claim 10, wherein the photo-thermal reaction is induced by a laser emitted from the tunable light emitter.

19. The method of claim 10, further comprising calculating a difference between a reflection percentage of the background and the reflection percentage of the target for each of the one or more wavelengths; and prioritizing transmission of wavelengths with the greatest difference.

20. The method of claim 10, wherein the plurality of light wavelengths transmitted to the target and the background comprises a visible spectrum, UV, IR, or a combination thereof.
